(19) United States
(12) Patent Application Publication
(10) Pub. No.: US 2021/0104166 A1
(43) Pub. Date: Apr. 8, 2021

(54) METHOD OF PRODUCING A BOOK COMBINED WITH DIMENSIONAL ELEMENTS AND PAGE ELEMENTS

(71) Applicant: Shundra L. Linton, Oxford, GA (US)

(72) Inventor: Shundra L. Linton, Oxford, GA (US)

(21) Appl. No.: 16/948,821

(22) Filed: Oct. 1, 2020

Related U.S. Application Data
(60) Provisional application No. 62/909,522, filed on Oct. 2, 2019.

(51) Int. Cl. G09B 1/02; G09B 23/18; G09B 19/00; G09B 23/12; G09B 23/24; G09B 5/06

(52) U.S. Cl. CPC G09B 1/02; G09B 23/181; G09B 19/0069; G09B 5/065; G09B 23/24; G09B 23/188; G09B 23/12

(57) ABSTRACT

A method of producing a book with recessed page element adapted to movably house dimensional elements for teaching STEAM-related lessons to readers.

### CROSS-REFERENCE TO RELATED APPLICATION

This application claims the benefit of priority of U.S. provisional application No. 62/909,522, filed 2 Oct. 2019, the contents of which are herein incorporated by reference.

### BACKGROUND OF THE INVENTION

The present invention relates to devices and methods for teaching science, technology, engineering, arts, and mathematics (STEAM) and, more particularly, a method of producing a teaching aid for STEAM-related lessons embodied in a book adapted from dimensional elements that furthers the teaching of STEAM-related lessons.

Science is generally a subject that most children find uninteresting. In fact, the lack of interest in science and technology amongst students has necessitated implementing a strategy for teaching science and related fields called STEM/STEAM to generate future professionals in the field. Currently, other STEM products come in a package and allows the user to utilize the parts via instructions to learn about the subject matter. Children may never engage in the product again unless prompted by their parents to do so.

Current teaching methods prompt the student to follow the standard way of learning by following directions from a book without any creativity. As a result, today's approaches to teach STEM do not take into account the creativity that children have and love to use. This is critical as a substantial amount of research strongly correlates learners' play and the impact the lesson being learned has. However, this method allows art to make the subject matter fun and memorable.

Furthermore, current teaching apparatus are typically kept boxed away from view, not used, and out of the mind of potential learners, as opposed to being constantly on display where lessons can be utilized by inquisitive children who are with eyeshot.

Separately, creating dimension in art has been a challenge for many would-be creators. Some people overcome this challenge by taking classes to learn how to mimic dimension in their art. Some people try to achieve dimension by purchasing things like dimensional paints to obtain a raised effect. Such approaches can get expensive and the user might not achieve their desired result, and so settle for less quality. Also, current approaches to creating dimensional art do not allow for much customization.

As can be seen, there is a need for a method of producing a book adapted from dimensional elements for teaching readers STEAM-related lessons. The present invention involves the creativity and customization of the user to make the STEAM-related subject matter more meaningful and fun. The STEAM-related subject matter may be retrievably and movably housed in a portable, recessed book so that the subject matter is accessibly by the inquisitive who can revisit, manipulate and relearn the STEAM-related lesson whenever and wherever. In short, the present invention answers the age-old question, “how am I going to use this in real life”, through enabling children to explore STEAM in a format that is fun, engaging, interactive, and memorable, and allows for playful engagement, making the STEAM-related material more impactful for each learner.

Furthermore, the method embodied in the present invention can be utilized to produce a book, dimensional elements and page elements, where even a novice will be able to create dimensional works of art and be able to customize it to a great detail yet easily achieve desired results. The book is constructed in such a way as the art and elements are protected from damage, and the book contains or directs any products involved or created for little to no cleanup. Specifically, the book created through the present invention incorporates the creation of dimensional elements in a way that is interactive, easy and foolproof.

### SUMMARY OF THE INVENTION

In one aspect of the present invention, method of producing a teaching aid for science, technology, engineering, arts, and mathematics (STEAM) related lessons, the method including the following: providing one or more dimensional elements, each dimensional element having a demonstrative component and an operatively associated operative component, the demonstrative component configured to provide a demonstration of STEAM, and wherein the operative component directly or indirectly urges said demonstration of STEAM; providing two or more frames, each frame defining a recess; and joining each dimensional element to at least one or more frames in such a way that the demonstrative component is disposed inside the recess; binding the two or more frames in such a way that the two or more frames are movable relative to each other between a closed position and an open position wherein the two or more frames are successively visible, wherein the demonstrative component comprises at least a hinge and the operatively associated operative component comprises at least a handle, wherein the demonstrative component comprises at least a ball and the operatively associated operative component comprises at least a plunger; attaching a page backing along one side of each frame so that the page backing further defines the recess, respectively; and attaching a transparent page cover along another side of each frame so that the transparent page cover further defines the recess, respectively, and wherein the book is adapted so that a user is enabled to reach into the page to interact with the dimensional elements. Further adaptations include multiple page coverings within the page element and along either side of the page element in lieu of or in addition to a page backing to further define the recess; also, arranging the page elements and frames where they attach to a spinning base and where frames and page elements are perpendicular to the base and the frames or page elements stand vertically from the base to create a star-book styled book.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention shown with cover 32 open;

FIG. 3 is an exploded view of an exemplary embodiment of the present invention with spine flap 48 not shown and cover 32 shown as open and cutaway for clarity;

FIG. 4 is a section view of an exemplary embodiment of the present invention, taken along line 4-4 in FIG. 1;

FIG. 5 is a section view of an exemplary embodiment of the present invention, taken along line 5-5 in FIG. 4;

FIG. 6 is a section view of an exemplary embodiment of the present invention, taken along line 6-6 in FIG. 5;

FIG. 7 is a detailed exploded view of an exemplary embodiment of the present invention showing the screw eyes 52 in lieu of latch pegs 26 for ring binding;

FIG. 8 is a perspective view of an exemplary embodiment of the present invention with interactive dimensional elements;

FIG. 9 is a perspective view of an exemplary embodiment of the present invention with interactive dimensional elements; and

FIG. 10 is a perspective view of an exemplary embodiment of the present invention with interactive dimensional elements.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include a method of producing books that, combined with dimensional elements and page elements, teach STEAM-related subject matter.

Generally speaking, the method of production or manufacture of the present invention embodies substrate-building materials and other items used to build up a relief on top of the substrate material for desired effects, wherein dimensional elements occupy a recess of each page element. The creator may fashion the substrate-building material to form any pieces needed, wanted or desired to achieve the desired results or effects. The resulting pieces are referred to as dimensional elements, which can be any piece or pieces of substrate-building material that has been created for dimensional effects.

The present invention may embody the following components:

Substrate—the material to which the substrate-building materials and other elements can be attached.

Base—the combined substrate and substrate-building materials.

Frame—a device used to surround the base. Attaching or affixing the base to a frame produces a page element.

Page element—the result of affixing the base to a frame or anything created for page material, the frame or the base, including combined elements to form a book or to be used as standalone pieces. In some embodiments, after completing the desired number of page elements, the page elements are joined together to form a book.

Cover—any material used to enclose, either entirely or partially, to produce desired effects.

Literature—reading material or instructions for the book. Literature could be written, audio or combinations of these.

A method of using the present invention may include the following steps. In step 1, a creator can begin by producing dimensional elements using any manner of tools, instructions, templates or substrate-building material, which may include anything the creator deems necessary to produce dimension in the finished piece. In step 2, the creator may join the dimensional elements created in step 1 to a substrate for producing a base. In step 3, the creator may join the base to a frame; thus, producing a page element. In step 4, the creator may join or attach the page elements to form a book. In step 5, the creator can add a cover and literature. The construction of the book can include page elements, dimensional elements, covers, literature or bases as well as any elements desired or any combination of these items.

By following the above-listed steps, in the order listed or by varying them by design, a book that has a recess to house moving parts that uses STEAM for moving pieces that illustrate the book and teach STEAM can be made. Steps 1-3 could be used to form a standalone page element that could be used in any way desired such as a wall-hanging picture. Also, any single step listed could be used to create a standalone page element which could be used alone or in the book. Exclusion of one or two components in the steps listed above does not preclude production of page elements or the book. Page elements and resulting books can include only dimensional elements, only bases, only frames or dimensional elements and affixed substrates as well as combinations of these. Adding more and varied types of dimensional elements such as mechanical and electrical devices or page dividers and literature elements can enhance the books entertainment value.

By performing steps 1-4 and creating dimensional elements that can form page elements, a creator can take the dimensional pieces to create easy to construct art pieces or books if the page elements are attached. The resulting elements will easily showcase the dimension that was incorporated in the elements.

Steps 1-3 could be used to form a standalone page element that could be used in any way desired such as a wall-hanging picture. Also, any single step listed could be used to create a standalone page element which could be used alone or in the book.

Exclusion of one or two components in the steps listed above does not preclude production of page elements or the book. Page elements and resulting books can include only dimensional elements, only bases, only frames or dimensional elements and affixed substrates and such as well as combinations of these.

In some embodiments, any component of the book may have an open cavity with a closure with the ability to be sealed. Hinges may be used to connect the separate page elements to form the book; however, the style of book and type of connecting device could be anything deemed desirable such as connecting the page elements to a rotating base, substrate, frame or device (for example, a lazy-Susan device) to create a moving star-book styled book. Attachment methods can include any type deemed desirable to achieve the effects sought after. In some embodiments, the page elements may be dimensioned and adapted to retain and/or use fluids therein.

The creator can utilize a guide or template, stencils, molds, metal dies, die cuts or any such tools or materials, instructions or combination of tools and materials deemed suitable in creating dimensional elements, frames, covers, bases, literature or any components used in the construction.

The frame may be constructed to have one or more front or back or dividing covers of any sort or kind of materials, shape, size, opacity or form whatsoever as well as be used in any combination of front or back covers. The cover need not enclose the entire frame or base or dimensional elements within the page element, but can enclose any portions of the frame, base or dimensional elements and may be of any design or form, e.g., opaque or clear, may be permanently attached or not and comprise of any material whatsoever. Also, any or all portions of the frame may be constructed to have any size walls including but not limited to walls that are higher than that of the base, or not having a frame at all. Also, covers may be in any orientation to the frame.

The components of the page elements or book do not need to be affixed permanently but can be attached using items that produce a temporary effect, enabling subsequent alterations. Alternatively, the components can fit snugly into place such as using joints to combine elements, using repositionable glue, using hook and loop tape, movable tabs or sliding the edges of one component under the edge of another fixed or stable component. However, any manner of permanently affixing components of page elements or books may be used as deemed necessary and as desired to create artwork or professional products suitable in the publishing/book industry.

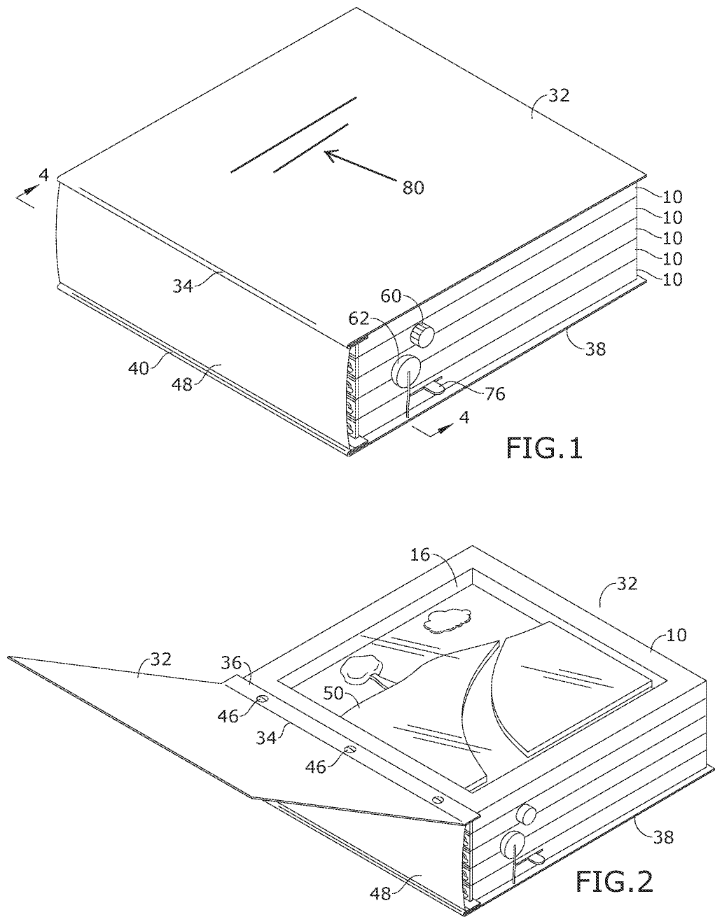

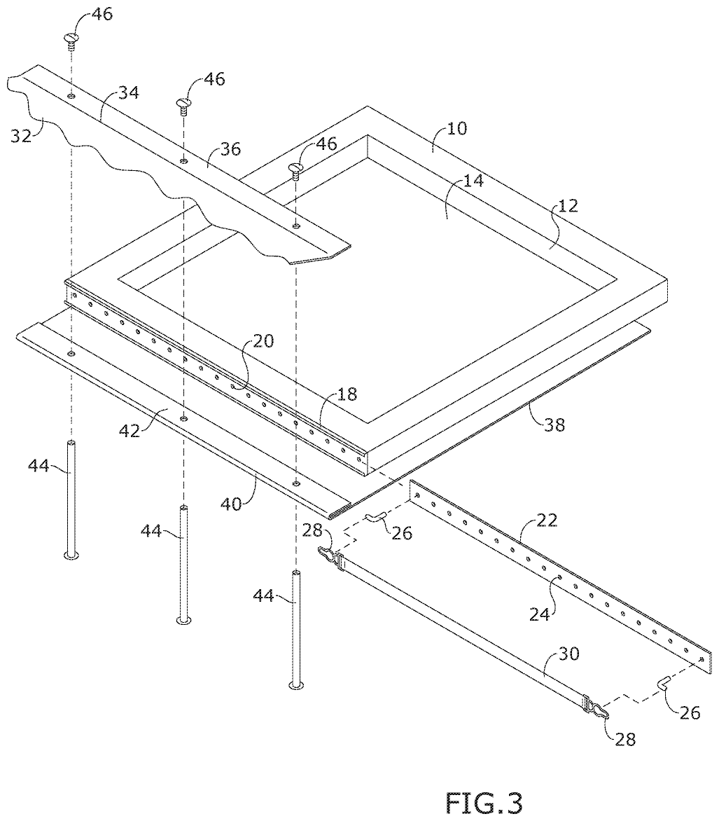

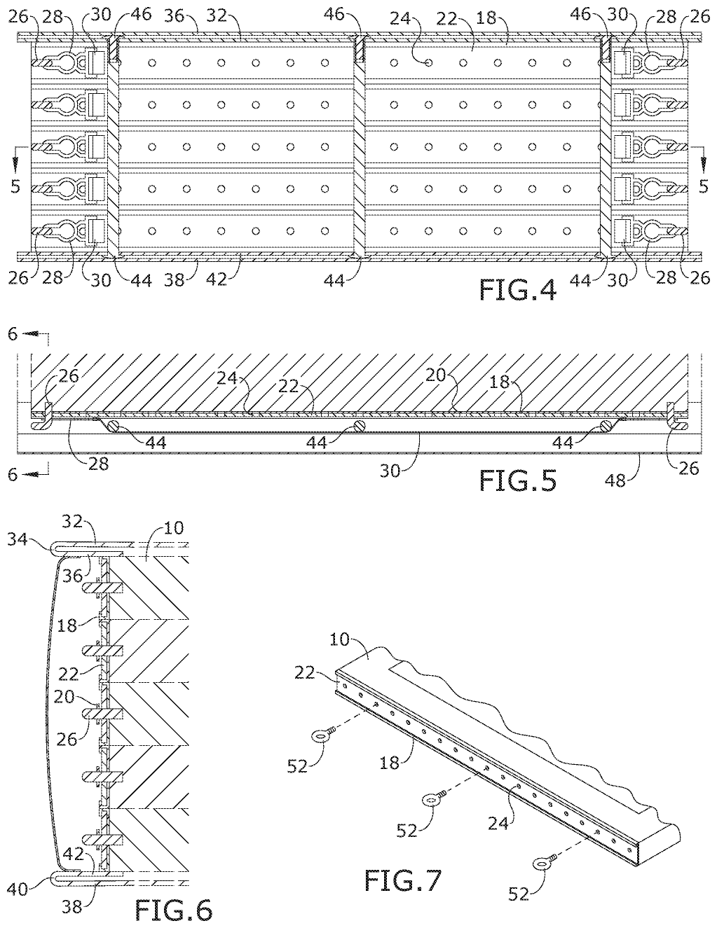

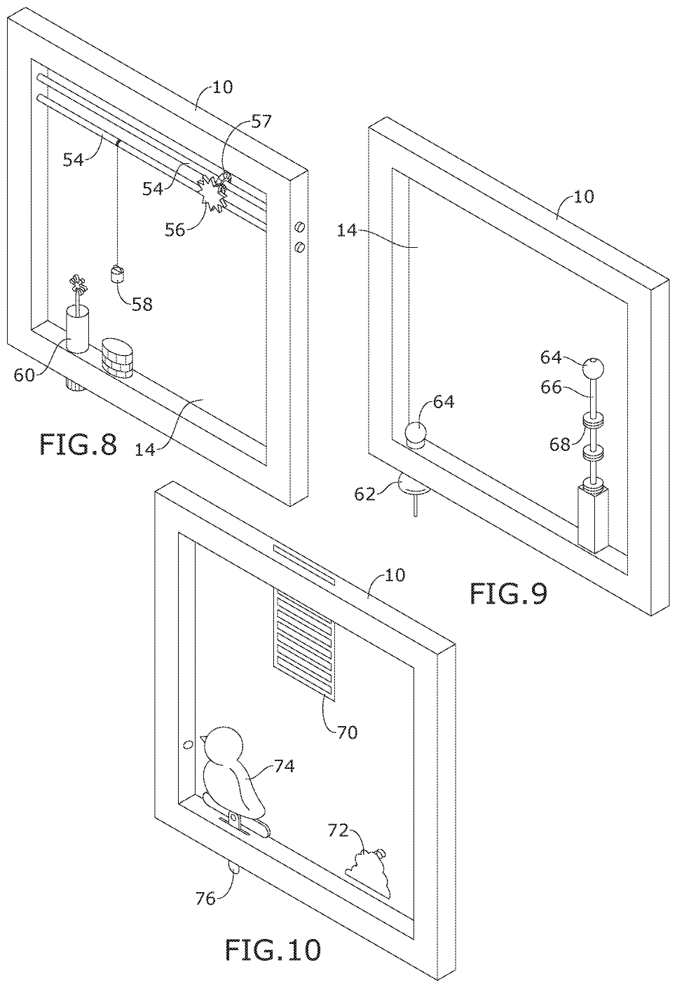

Referring now to FIGS. 1 through 10, the present invention may include a method of producing a STEAM-related book combining dimensional elements and page elements as well as covers and literature to foster an interest in STEAM principles from the STEAM related housed in the books. The page elements may include page frames 10, page recesses 12, page backings 14, and page covers 16. The page covers 16 could be transparent or opaque.

The page frames 10 may include tracks 18 and track holes 20 for operatively associating with slats 22 with slat holes 24 so that latch pegs 26 or screw eyes 52 can engage strap hooks 28 of straps 30.

The cover may include a front cover 32 having a front cover (living) hinge 34 and a front cover post mounting flap 36 so that a rear cover 38 having a rear cover (living) hinge 40 and a rear cover post mounting flap 42 can be operatively associated by way of binding barrels 44 and screws 46. A spine flap 48 may extend from the front cover 32 to the rear cover 38 for obscuring many of the cover components. The front cover 32, rear cover 38, page cover 16, page backings 14, or any component of the book may include messages 80, such as “Once Upon a Time . . . ”, symbols, text, displays or the like.

Dimensional elements 50 may include turnable rods 52, geared spinning elements 54, a spring element with pinion gear 56, a rod gear 57, raise/lower elements 58, turn-activated extension/retraction elements 60, ball shooting plungers 62, a ball 64, a ball post 66, a magnet 68, a pull-activated lecticular image 70, a spring-mounted element 72, a hinged element 74, a hinged element handle 76, or the like.

### Specific Embodies Include the Following:

### Simple Machines—Screwy Flower

Take a twelve-inch by twelve-inch canvas frame that has a recess at least one-half inches high. Place the frame canvas-side down. Take a thin sheet of cardboard and pierce a nail hole in the cardboard base about one-third of the way down from the top edge of the cardboard edge and place a half-inch nail through the hole you pierced through the cardboard. This will serve as a base. Place the base in the recess of the frame and slide it so that its edges slide under the edges of the frame edges. Attach a gear to the top of the nail adding pony beads underneath and one crimp bead above until the correct height is reached. Crimp the crimp bead to secure the gear into place. Drill a three-eighths inch hole in the bottom edge of the frame. Drill two holes opposite each other on the left and right sides of the frame measuring approximately one-eighth inches diameter making sure to drill only half the length of the side to which the frame will be connected to the binding and so that it intersects perpendicularly the screw in the cardboard base. Cut two one-eighth inch dowels to the length of these holes drilled in the left and right sides of the frames adding two extra inches. About two inches down from the first set of holes drilled in the left and right sides of the frame, drill two more one-eighth inch holes in the same fashion as the first set of holes. Place a one-eighth inch dowel in the upper set of holes drilled in the left and right side of the frame making sure to place a gear onto the dowel once the dowel has passed through the hole. Line the gears up so that they interact. Place the other dowel in the other set of holes but attach a string to this dowel. Each of these dowels will rest inside the recess drilled in the other side of the frame and remain free to spin. Place an empty lip balm container into the three-eighths inch hole so that the portion that a person turns to make the lip balm container rise is on the outside of the frame. Create a flower by attaching a two inch piece of plastic-coated wire to a cutout of a flower head. This is a dimensional element. Attach this dimensional element to the platform in the empty lip balm container. Cutout a circle and draw a sun on the face and attach this to the gear attached to the nail. Make a bucket dimensional element by using the lip balm container cap and piecing two holes in the cap then bending wire to go through those two holes. Attach the string on the lower dowel to this dimensional element. Create a well out of paper and create the scenery of sky and land out of paper. Attach these dimensional elements to the base. Now, turn the handle for the gear to make the sun spin. Turn the other handle to raise the bucket pulley to water the flower. And, spin the screw in the glue stick to make the flower raise and “grow.”

### Help Birdie Fly

Take a twelve-inch by twelve-inch canvas frame that has a recess at least one-half inches high. Place the frame canvas-side down. Cut a slit in the bottom and top edge of the wooden part of the frame from one side to the other. Drill one-eighth inch holes half way up the right side of the wooden part of the frame. Take a thin sheet of cardboard that will serve as a base. Place the base in the recess of the frame and slide it so that its edges slide under the edges of the frame edges. Take two pompoms, one smaller than the other, and attach them using glue. Obtain a skewer and cut off a half inch from the pointed end. Attach this to the smaller pompom forming a beak. Take a Popsicle stick and cut it in half. Take a nail and pierce a hole in the middle of each Popsicle stick then lay them perpendicular on one another making sure to line up the holes. Insert a brad into the hole. Attach a magnet to the side of the Popsicle and brad structure that faces the canvas on the horizontal Popsicle stick. Attach the pompom bird onto the brad and Popsicle structure that faces up from the canvas attaching it to the vertical Popsicle stick. Lay the bird-Popsicle structure on the base making sure that the Popsicle stick that is vertical can be accessed through the slit made in the bottom of the frame. Move the handle on the bird structure so that it touches the sidewall closest to it. Take a small clothes pin and open it placing one side of the pin in one of the holes drilled along the side of the frame and placing the other side of the pin in the adjacent hole making sure they line up with the bird's beak. Take a picture of an acorn and cut it in half. Attach each half to the side of the small clothes pin. This will act like a wedge simple machine. Attach a magnet to the backside of the frame opposite the bird-Popsicle structure. Obtain two sheets of cardstock, one dark colored and one white. The dark cardstock measures eight and one-half inches by five and one-half inches and the white cardstock measures four inches by seven inches. Score the dark cardstock in the middle, mark three-eighths inch from the half point of the cardstock then each edge on the top half of the cardstock. Then cut slits every one-eighth inch across the cardstock. Cut every other slit at the top and bottom so that it resembles bars. Place the white cardstock underneath the dark cardstock and stamp images through the dark cardstock onto the white cardstock using a solid or nearly solid stamp using a dark ink. Then, move the white cardstock so that the image you stamped is hidden behind the dark cardstock's bars. This time stamp the image at the same spot on the page but make the angle different. Fold the dark cardstock in half, cut a half circle through the end of the dark cardstock as a finger pull, then, use one-eighth inch score tape or an adhesive applied in a thin line along the opposite side of the fold line and the opposite side of the finger pull to close the dark cardstock into a pocket for the white cardstock to fit into. Attach the pocket to the topside of the base so that the finger pull's edge faces the top edge of the frame where the slit was made. Insert the white cardstock through the slit in the frame and into the pocket. Now, you can move the white cardstock to see the image move. This happens because lenticular images work by the offset position of the two stampings through the movement of the grid which causes the brain to think that the images are moving. Make bird eat the acorn by manipulating the vertical Popsicle stick through the slit in the bottom of the page. Then, make bird fly by accessing the magnet on the backside of the frame.

### Literature Pulley

Take a twelve-inch by twelve-inch canvas frame that has a recess at least one-half inches high. Place the frame canvas-side down. Take a thin sheet of cardboard that will serve as a base. Place the base in the recess of the frame and slide it so that its edges slide under the edges of the frame edges. Drill two holes opposite each other on the left and right sides of the frame measuring approximately one-eighth inches diameter making sure to drill only half the length of the side to which the frame will be connected to the binding. Cut two one-eighth inch dowels to the length of these holes drilled in the left and right sides of the frames adding two extra inches. About six inches down from the first set of holes drilled in the left and right sides of the frame, drill two more one-eighth inch holes in the same fashion as the first set of holes. Place a one-eighth inch dowel in the upper and lower set of holes drilled in the left and right side of the frame. Take a sheet of paper measuring 11 inches by 24 inches and write or draw any literature or pictures on the sheet you want leaving a half inch at the top and bottom free of marks. Attach the top portion of the sheet to the top dowel and the bottom portion to the bottom dowel making sure the writings, literature and markings are facing the top. Now, move the handles to make the paper wind up around the dowels. Add a cover to the top of the frame by using a twelve-inch by twelve-inch piece of paper with a hole cut out of the center that matches your sheet width. The height can vary depending on the size of your drawings so that it acts like a tv screen. Add a sound recording and playback button to the bottom center of the page that has been prerecorded with your message and has batteries installed. Now, you can move either handle to make the scroll show what you marked on your paper. It's a pulley for animations and literature. Push the button to make the button tell the story. This is particularly good for young and developing readers.

### Ban Game 1

Take a twelve-inch by twelve-inch canvas frame that has a recess at least one-inch high. Place the frame canvas-side down. Take a thin sheet of cardboard that will serve as a base. Mark dots with corresponding numbers on the bottom half to two thirds of the cardboard base. Place the base in the recess of the frame where the numbers and dots are visible and slide it so that its edges slide under the edges of the frame edges. Drill two holes on the left and right sides of the frame measuring approximately one-half inches diameter making sure to drill only half the length of the side to which the frame will be connected to the binding and make the hole that is on the side where the binding will occur have a lower position in the frame by approximately one-inch. Cut one one-inch paper tube to the length of these holes drilled in the left and right sides of the frames adding one extra inch. About six inches down from the first set of holes drilled in the left and right sides of the frame, drill one two-eighth inch slit in the side of the frame that is opposite the side where the binding will be placed. Place a one-eighth inch by one-inch wooden slat in the lower slat and cut it where it makes contact with the bottom of the frame at an angle but not touching the inside edge of the frame and where it sticks out of the slat by two inches. Sand the cut edge. Then, cut a three-eights inch hole in the middle of the paper tube. Insert the tube into the upper holes. Use glue to secure the pipe into the holes if needed. This will act as an inclined plane. Take a twelve-inch by twelve-inch sheet of clear plastic and make a cut one-inch away from the corner that is below the slat made in the wood. Fold up the corner to form a door with a living hinge. Attach this clear plastic sheet to the front opening of the canvas frame. Make a three-eighths inch ball out of clay or Styrofoam™. Place the ball into the opening of the paper tube which serves as the inclined plane. It drops through the hole made in the tube into the chamber of the covered recessed frame. Use the lever to make the ball jump into the air. The fulcrum is the point where the wooden slat hinges against the side of the frame's opening. If the ball goes under the lever, the person can retrieve the ball and begin again by accessing the ball through the hinged door in the clear cover. This game has math incorporated by adding up the points earned before losing the game.

### Ban Game 2

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Take a twelve-inch by one-inch piece of cardboard and glue it in the center of the base perpendicular to the base. Make markings on the surface of the cardboard denoting measurement heights. Drill one hole five-eighths inches in diameter on the bottom edge of the canvas frame that is three inches distance away from the left edge of the frame. Drill a one-eighths inch hole partially through the bottom edge of the frame that is three inches away from the right edge of the frame. Then, drill another one-eighths inch hole through the top edge of the frame three inches away from the right edge of the frame. Cut a one-eighths inch dowel to twelve-inches and place this through the hole in the right side of the frame and placing a styrofoam ball with a one-fourth inch hole in its center and three ring magnets with their poles facing each other in alternating fashion onto the dowel before placing the dowel into the partially drilled hole on the bottom part of the frame. The dowel can have repositionable glue or double-sided tape adhered to the bottom of it for securing it in a repositionable fashion to the frame. Next, cut a plastic tube with a cap measuring five-eighths inches by one-inch and cut four slits halfway into the tube across from one another. Cut three pieces of elastic string one and one-half inches long. Take two of the elastic strings and lay them perpendicular across the opening of the cut tube into the slits and tie a knot at the end of each string. Take the third string and catch both strings across the opening of the tube and tie them in a knot. Then, make a hole in the cap big enough to fit the elastic string. Run the third string through the hole made in the cap. Place this tube into the hole made in the left side of the bottom of the frame. Apply glue to secure the tube if necessary. Take a clear twelve by twelve-inch cover and adhere the top portion to the frame with glue. Cut the cover in half. Lift the cover and add a one-half inch clay ball to the left side of the frame. Now, make the balls jump by either pulling on the string and letting go once the clay ball is inside the tube so that the ball can take advantage of the potential energy of the person's recoil of the elastic string; or, depress the styrofoam ball which takes advantage of the force the disk magnets exert due to the magnetic repulsion of the same sides of the disks being forced together and flying apart to find equilibrium. Math is also incorporated into this game by measuring the heights the ball reach. Add the scientific theory by making it an investigation to see which has more force then change the type of elastics, ball material and number and type of disc magnets.

### Climbing and Descending

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Take a twelve-inch by one-inch piece of cardboard and glue it in the center of the base perpendicular to the base vertically. Drill four holes one-eighths inches in diameter on the bottom and top edge of the canvas frame that is three inches distance away from the left and right edge of the frame. Cut a string that is at least 26 inches long. Obtain a matchbox and poke nail holes approximately sized 2 mm in the middle of the 4 thinner edges directly across from each other. In one set of holes place a skewer and flush cut the edges of the skewer. Then open the matchbox and thread the thin, yet strong string through the other hole and wrap it around the skewer in the middle of the box one time and then through the other side of the box. Close the matchbox. Cut out a picture of a spider or make a spider dimensional element using clay. If you make the dimensional element using clay it will be heavy enough without adding additional weight; however, if you use paper add a penny or a lump of dry clay to the interior of the matchbox to give the structure weight. Attach the dimensional element to the top of the matchbox. Then, string the top and bottom of the string through the top and bottom of the left side of the framed page and tie the two ends together in the front of the page. Now, take three large ice cream sticks and mark the centers of each. Cut two of them in half and take an extra half inch from the center of the third making sure the two pieces for the third ice cream stick are the same measurement. Color the three sets of sticks before assembly. In the first pair of center cut sticks, mark 1 cm from the cut end and drill a 2 mm hole through the center of each stick. Then, for the second pair of center cut sticks make markings for holes at 0.8 cm, 3 cm, 5 cm and 6.5 cm from the cut ends. Drill 2 mm holes in these center of the sticks at the specified locations. Then, in the shorter pair of sticks, make markings at 2.2 cm and 4.8 cm from the cut ends and drill 2 mm holes in the center of the sticks at those locations. Take the pair of center cut sticks that have one hole drilled through the center at the 1 cm mark and glue them together aligning the holes and placing a skewer through the holes. Cut the skewer flush with the ends of the sticks. Then, take a piece of foam tape and shape it to match the stick that has the two holes drilled into it. The foam tape should match the two holed stick from the curved edge of the stick to the first hole closest to the curved edge. Stick down the foam tape to the stick. Glue the stick with one hole to the inside of one of the sticks with two holes leaving about 15 mm of the curved portion of the stick with one hole sticking out. The placement will be near the cut end of the stick with two holes. Glue the other stick with two holes on top of the stick with one hole in the same direction as the other stick with two holes aligning the holes made in the sticks. Then, align and glue one of the center cut sticks with four holes to either side of the center cut stick with one hole perpendicular to one another and aligning the one hole in the stick with one hole to the hole nearest the cut line in the center cut stick with four holes. Place a skewer through this hole and flush cut it to the outer edge of the ice cream sticks. Insert skewers through all holes in the center cut four holed sticks except the one set of holes nearest the set of sticks with one hole. Flush cut. Take a rubber band and position it so that it will get trapped when you insert the final skewer in the hole in the center cut four holed stick nearest the one holed stick. Place the skewer through the holes while maintaining the position of the rubber band. Flush cut. Do the same to the last remaining hole in the set of sticks with two holes drilled in them. Now, take an 18 inch strong but thin string and run it between the foam tape and its nearest skewer. Take a skewer and lock this string into place. Flush cut the skewer. Run the string between the two middle skewers of the center cut stick with four holes in it, then run the string under the skewer adjacent to this headed toward the curved portion of the ice cream stick, then, over the last skewer adjacent to this that is nearest the curve of the ice cream stick with four holes. Take the top edge of the string and run it through the hole in the top edge of the page and make a knot sufficient enough to keep the knot from going through the hole and do the same to the bottom of the string. If needed, a bead attached to either end of the string could be fitted to keep the string at either end of the page. Now, take the string in your hand and pull. As you pull, the alignment of the string straightens the legs which are attached to the body by lever action. This causes the toy to stretch up the string. But, once the stretching stops, the area where the foam tape is housed has more friction and the rubber band pulls up the legs causing the climber to climb. Taking the string on the spider side and pulling it taut causes friction on the string due to the fact it is wrapped around the dowel in the center. So, pulling the string causes the spider to stop moving. However, letting a little slack in the string will cause the spider to fall due to the weight the dimensional element has and the action of gravity without there being any friction or tension in the string to stop gravity.

### Channeled Friction Movement

Take a twelve-inch by twelve-inch canvas frame that has a recess at least one-half inch high. Place the frame canvas-side down. Take a thin sheet of cardboard that will serve as a base. Place the base in the recess of the frame and slide it so that its edges slide under the edges of the frame edges. Make dimensional elements out of paper and clay to decorate the surface of the cardboard creating the scene for your page. Drill two 2 mm diameter holes on the bottom edge of the canvas frame right next to one another. Take a sheet of paper 4.25 inches by 11 inches. Fold the paper in half shortways. Then fold this into half the longway. Open the last fold and bend the top folded edge from the corners down to the center making what looks like a pointed roof house. Lift the right corner, open the edge, push the corner inside the fold of the paper. Do the same to the left side. Flip the left side to the right side and take the last fold on the right side and bring it to the left side. What you should have now is a pointed roof at the top with two strips coming down on either side where they are not connected. Then, cut off the top triangle leaving about a half inch below attached to the two strips extending below. Draw a face on the triangle you cut out and add a curvy tail. Color the long strips to match the background. Attach two skewers the length of the strips plus two inches to the long strips so that they can't be seen. Insert the bottom edge of the skewers into the holes in the bottom of the page. Tuck the long strips of the folded paper into the triangle's flaps. Now, alternate the skewers up and down and watch the sting ray you created move up the channel and come out at the top by the friction you are creating by moving the skewers in the page.

### Cartesian Diver

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Make dimensional elements using clay and paper to create a scene for your page. Make a dimensional element made of clay in the shape of a seahorse. Before the seahorse dries, take a paper clip and a straw. Cut the straw to about an inch. Fold one end over the paperclip until it reaches the top curve. Stick the paperclip into the clay seahorse making sure not to block the straw's hole and let it dry completely. Drill a five-eighths inch hole through the top edge of the frame. Take a container no bigger than twelve-inches by twelve-inches, Ideally, the container is twelve-inches by 2 inches by 1 inch with a screw-top and living hinge that seals a one-eighth diameter hole. Attach this container to the base and bottom of the page. Once the seahorse dimensional element is completely dry, place it inside the screw-top container and add water leaving about a half inch of space at the top. When ready to conduct the experiment, make sure the page is facing forward and the top side of the page is facing up. Take a medicine bulb and place the tip of the bulb inside the container via the one-eighth hole in the screw-top lid. Depress the bulb and watch the seahorse sink to the bottom of the container. When finished, remove the bulb and replace the lid on the container. The pressure the additional air gave to the container was enough to counter the bouy of the air in the straw to make the seahorse sink.

### Lenz Law Elevator Versus the Blob

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Drill one hole five-eighths inches in diameter on the top edge of the canvas frame that is on the left side of the centerline of the frame and a partial hole at the bottom of the left side of the centerline of the frame. Then, partially drill a five-eighths inch hole in the bottom of the frame on the left side of the centerline. Drill a five-eighths inch hole partially through the bottom edge of the frame that is on the right edge of the centerline of the frame. Drill a hole the same size at the top of the frame in the same location. Take two syringes without needles and a six inch length of three-eighths diameter plastic tubing. Make a solution of colored water. Suck up the colored water into both of the syringes and connect the syringes with the tubing Take a paper tube about a half inch in diameter and cut a three-eighths circle to fit in the tube. Cut a hole about halfway in the pipe extending from halfway up the pipe to six inches up leaving the back part of the pipe connected and uncut. Insert the syringes so that the flat handle of one extends through the bottom of the paper tube and sits as the platform of the elevator while the other handle extends through the five-eighths inch cutout in the bottom of the frame. Attach the three-eighths inch paper circle to the syringe handle. Attach a 6 inch piece of ribbon or fabric to half of the edge of the syringe to mask the handle as it goes up and down. Take a small, clear half inch by half inch round container with a lid and fill it with iron filings and mineral oil. Place this on the syringe platform. Take a piece of clear plastic and cover the opening made for the elevator using repositionable glue or tape. Take a half inch copper pipe that is twelve-inches long and set it into the hole on the left side of the frame. Then, insert the tube with syringes into the right side of the frame. Apply a sheet of twelve-inch by 6.5 inch magnetic flux detection sheeting over the left side and part of the right side of the page. Using a set of strong magnets, drop the magnets down the copper pipe and note what happens. They fall slowly due to Lenz's and Faraday's law and you can see the magnetic field due to the flux detector sheet. However, when the magnets encounter the blob of iron filings the descent stops and the magnets are immediately attracted to the iron filings while the iron filings show the magnetic field. Try to free them by moving the elevator by using the syringe handle in the bottom of the frame. In order to get the magnets out, remove the jar of iron filings and use them to coax the magnets down the copper pipe.

### Zeotrope

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Take a compact disk or CD, a low profile fidget spinner, and a printout of a low-profile zeotrope printout such that all of these elements together do not exceed the one-inch border afforded by our frame, and assemble them so that the fidget spinner in attached to the base and is free to spin, the CD is attached to the fidget spinner and is free to spin, and the zeotrope printout is attached to the edges of the CD. The zeotrope has cutouts above the figures that act as frames. The figures are drawn in succession to show moments in time of a figure doing an action. So, when a person looks through the cutouts at an angle to the figures below the cutouts and while spinning the device counterclockwise at a sufficient speed it will appear that the figures are moving.

### Archimedes Screw Space Mining Expedition

Take two twelve-inch by twelve-inch canvas frames that has a recess at least one-inch high. Take off the canvas and place a twelve-inch by twelve-inch acrylic sheet in between the frames. Glue the frames to the acrylic sheet making a two-sided frame with a clear viewing window to the other side of the page. Take a twelve-inch by twelve-inch sheet of cardstock and decorate it with stars and other shapes to look like a scene from outer space. You can make dimensional elements that look like moons and planets out of styrofoam or clay and attach them to the top frame using thin string. Take a thin sheet of cardboard and attach the cardstock to the cardboard. Adhere the cardboard it to the back of the double page so that it shows the drawings. Cut a five-eighths hole in the top of the second framed page. Cut a one-half inch paper tube to 10 inches long. Take a piece of mirror paper that is cut 8 inches long and wrap it around the one-half inch tube. Poke holes in the paper in a random fashion. Mark the edge of the paper to show the diameter of the tube and cut along that line. With the cut mirror paper form a triangular prism with the mirrored face facing inwards and tape it closed. Slide this prism inside the paper tube. Cut a three-quarter inch diameter circle and cut a three-eighths inch circle in the center of that circle. Glue this circle to the edge of the paper tube nearest the side with the triangular prism inserted into it. On the other side of the paper tube cut a one-half inch circle out of thin but rigid plastic and insert this into the paper tube. Use a thin bead of glue on the outside of the circle to make sure it stays put. Once the glue is dry, half fill this two inch space with small, clear beads of many colors. Then, cut another half-inch circle and adhere this one to the outside of the paper tube which will hold in the beads. Let this dry. Decorate the outside of the paper tube and poke holes through the tube. Then, cut a six inch by five-eighths inch hole in the bottom to the middle edge of the back and front frame on the edge that is opposite the edge where the binding will be attached. Through the hole on the back frame insert and attach to the bottom of the page a magnetic stirrer and its cylinder with tight fitting lid and magnet in the bottom. To the cylinder add water, mica powder, glitter and confetti to show off the centripetal force once the magnetic stirrer is turned on. Make sure there are batteries in the magnetic stirrer before inserting into the page. Also, use repositionable glue or tape to attach the magnetic stirrer. The controls should be situated so that they are closest to the edge of the page with the hole for accessing the controls. Then, take a clear plastic pouch six inches by twelve-inches with a slide zipper and add a wedge of plastic to the interior of the plastic bag to hoist up the archimedes screw to ensure a narrow angle of 15 degrees or less is achieved. The archimedes screw is no longer than 15 inches including the handle and has a half inch diameter and has been slid into a half-inch clear pipe about twelve-inches long so that the pipe extends from the tip of the archimedes screw to the second to last thread at the top of the screw to allow for the beads to drop out of the pipe when the screw is turned. Put the archimedes screw into the clear plastic pouch with the zipper and add colored beads to the pouch and seal it using the zipper until it cannot close any further over the screw. Place this into the front part of the framed page so that the handle and part of the screw is sticking out of the page. Use repositionable glue or double-sided tape to adhere the bag to the inside of the frame. Then, take a twelve-inch by twelve-inch clear sheet of plastic acrylic and attach this to the front side of the framed double page. When ready, look into the kaleidoscope and turn it to see the images bounce off the mirrored surface and change. Then, use a flashlight to shine into the kaleidoscope and see the light shine onto the interior of the page. Even see the light being diffused through the beads at the bottom of the kaleidoscope and the patterns and colors they make in the page. Turn on the magnetic stirrer and see the centrifuge happen as the magnet causes a vortex in the cylinder of water and glittery stuff. Then, place a cup underneath the archimedes screw on the outside of the page and turn the archimedes screw to see the beads come up and out of the tube and into the cup.

### Galileo Thermometer

Take a twelve-inch by twelve-inch canvas frame that has a recess at least one-inch high. Place the frame canvas-side down. Take a thin sheet of wood that will serve as a base. Place the base in the recess of the frame and slide it so that its edges slide under the edges of the frame edges. Drill one hole five-eighths inches in diameter on the top edge of the canvas frame and drill a five-eighths inch hole partially through the bottom edge of the frame that is three inches away from the right edge of the frame. Take a tempered glass cylinder that has a screw on lid and partially fill the container with a mixture of alcohol and water. Obtain half inch spheres filled with a colored alcohol mixture and with a weight attached to the bottom denoting a temperature and add these to the cavity of the tempered glass container. Top off the volume of the cylinder with the alcohol mixture and seal the top onto the cylinder. Insert the cylinder into the page. The cylinder can have glue, double-sided tape or epoxy adhered to the bottom of it for securing it to the frame. Take a hair dryer and apply heat to the cylinder and note what happens to the carefully measured cylinders of liquid and weights as the temperature raises and then lowers again as the cylinder cools.

### Toilet Flush—Siphon Demo

Take a twelve-inch by twelve-inch canvas frame that has a recess of at least one-inch high and place it canvas side down. Cut a hole in the top of the frame leaving a one-eighth inch border all around the top. Cut a one-eighth inch hole in the bottom center of the frame. Take a thin sheet of cardboard that will serve as a base. Place the base in the recess of the frame and slide it so that its edges slide under the edges of the frame edges. Take a clear, plastic container measuring 11 inches wide by 9 inches high by one half inch deep with a lip that fits a hinged lid with an o-ring in the lid. Open the container by taking off the hinged lid. Then, cut a one-eighth inch hole in the center of the bottom of the container, insert a straight straw into the hole leaving a tail of about one-inch on the outside of the container. Then, apply half inch thick clay dough pieces to the bottom edges of the container sealing in the straw. Add a horseshoe made out of clay to the center of the container surrounding the straw and making sure there is one-inch space from the bottom of the container and at least a half inch of space from the top of the straw and the clay dough horseshoe. Attach the plastic container to the base using glue making sure the straw exits out of the one-eighth inch hole in the bottom of the page. Cut the straw coming out of the page to a length of about an inch. Attach a cap with a living hinge to the straw. Then, let the clay dry. When the clay is dry, make sure the page is upright and a bucket is underneath the page to catch the water. Take the cap off of the bottom of the straw. Take about three cups of water and a funnel and pour the water into the container. Watch as the water enters the container and fills to the point where the straw is open inside the container. Then, note how the water is pulled out of the container even after you finish pouring the water until the siphon is broken when air enters the horseshoe type structure in the container. When finished, replace the cap onto the bottom of the straw and close the lid on the container.

### Heron Fountain

Take a twelve-inch by twelve-inch canvas frame that has a recess of at least one-inch high. Place the frame canvas-side down. Take a thin sheet of cardboard that will serve as a base. Cut out a three inch circle in the base in the top center of the cardboard and in the canvas so that you can see through to the other side of the page. Place the base in the recess of the frame and slide it so that its edges slide under the edges of the frame edges. Take two 5 inch long screw top test tubes that have an opening one half inch in diameter and drill two one-eighth holes in the screw tops making sure the holes line up one on top of the other. Make a plastic triangle ring that have the same dimensions as the screw tops on the test tubes and drill two one-eighth hole in the center of it. Make sure to bend the handle of the triangle ring so that it sits at a 90 degree angle to the ring. Place the triangle ring in between the two screw caps lining up the holes and add industrial strength glue to the assembly to seal them together. Let this dry. Cut two one-eighth inch straws to four and a half inches long. Cut small holes in the straws starting from one-eighth inches up to one half inches up from the base of the straws. Insert the straw's base into the holes in the top assembly. There should be one straw extending one direction and the other straw extending the other direction. Add colored water to one of the test tube vials leaving a half inch gap of air and seal it onto one of the cap ends. Then, seal the other test tube vial onto the other cap end. Drill a three-fourths inch flat screw through the cardboard leaving a portion of the screw so that it doesn't touch the base. Attach the triangle ring to the screw head using industrial strength glue and a washer. Then, on the other side of the page, attach a nut and a large washer using industrial strength glue onto the other end of the screw. Use the large washer to turn the test tubes so that the fountain can work. This acts as a wheel and axle. Make a fountain using paper, irridescent ribbon, irridescent mylar and clay and attach this to the front side of the canvas while the test tube fountain is located on the other side of the page. When the large washer on the front side of the page is turned, it turns the fountain on the other side of the page. When this happens, it causes the water to move from one tube to the other by gravity. In doing so, it forces air up the tube along with water to look like the fountain is spouting.

### Color Changing Potions

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Drill two holes five-eighths inches in diameter on the top edge of the canvas frame that is three inches away from the left and right edge of the frame. Then, drill two five-eighths inch partial holes through the bottom edge of the frame that is three inches away from the right and left edge of the frame. Add half inch test tubes that are twelve.5 inches high and where the crew on caps are fully on the outside of the framed page located at the top of the page. The test tubes can have repositionable glue or double-sided tape adhered to the bottom of it for securing it in a repositionable fashion to the frame. To one test tube add full fat milk and two drops each of different color food coloring. To the other tube add red cabbage powder to water and stir thoroughly. When ready, use pipettes to add a drop of dish washing liquid to the tube with milk and food coloring and to the other tube add drops of either a strong base, like diluted washing powders, or a strong acid, like lemon juice. With the milk solution, the colors will mix due to the milk fat reacting to the surfactant in the dish washing liquid. In the cabbage powder solution, the cabbage powder acts as a litmus test and turns bright red in the presence of acids and dark purple in the presence of bases. Imagine the fun you could have turning this page into an interactive cauldron page.

### Hidden Objects—Water Marbles

Take a twelve-inch by twelve-inch canvas frame that has a recess at least one-inch high. Place the frame canvas-side down. Take a thin sheet of cardboard that will serve as a base. Cut a round 10 inch diameter hole in the cardboard. Take a piece of white cardstock and draw or write something on the bottom half of the page that you want to be hidden but revealed only to someone you give the secret of unlocking the puzzle. Place the drawing onto the canvas so that it shows through the hole in the cardboard. Then, place translucent water marbles in a clear plastic bag with half of the bag filled with water. Seal the bag of water marbles half filled with water and place the bag in a 10 inch round, clear container with a tight fitting lid. Put the lid on the container. Attach this container to a clear, thin acrylic sheet 11 inches in diameter. Place this container in the base where the acrylic sheet is behind the base and the container is nestled in the hole in the cardboard. Place the base in the recess of the frame and slide it so that its edges slide under the edges of the frame edges. Now, turn the container and see the hidden message behind. You can see the message through the water marbles due to diffraction. The water marbles become invisible when submerged in water because they have the same index of refraction with water.

### Hidden Message 2—Quinine Ink

Take a twelve-inch by twelve-inch canvas frame that has a recess at least a half-inch high. Place the frame canvas-side down. Take a thin sheet of cardboard that will serve as a base. Place the base in the recess of the frame and slide it so that its edges slide under the edges of the frame edges. Make markings or write a message on the surface of dark colored cardstock measuring twelve-inches by twelve-inches using quinine water as ink. Let the ink dry. Place the cardstock on the cardboard surface. Take the book or page into a dark area with a black light. Shine the light onto the surface of the page and read the hidden message. You can see the message under black light because quinine is a chemical that fluoresce in the presence of UV light.

### Mummy Hand

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Drill one hole five-eighths inches in diameter on the top edge of the canvas frame. Then, drill one five-eighths inch partial hole through the bottom edge of the frame. Add a half inch test tube that are twelve.5 inches high and where the crew on caps are fully on the outside of the framed page located at the top of the page. The test tube can have repositionable glue or double-sided tape adhered to the bottom of it for securing it in a repositionable fashion to the frame. Drill a half inch hole through the cap of the test tube. Attach a rubber glove to the cap by taping the glove to the cap. To the test tube add a half cup of vinegar. When ready, take the cap off with the glove attached and add a tablespoon of baking soda. Quickly replace the cap and watch the carbon dioxide fill the glove.

### Lava Lamp

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Drill a hole five-eighths inches in diameter on the top edge of the canvas frame. Then, drill a five-eighths inch partial holes through the bottom edge of the frame. Add half inch test tubes that are twelve.5 inches high and where the screw on caps are fully on the outside of the framed page located at the top of the page. The test tubes can have repositionable glue or double-sided tape adhered to the bottom of it for securing it in a repositionable fashion to the frame. To the test tube add colored water and oil. When ready, drop a seltzer tablet or two to the tube and watch the fizz churn the water and oil mixture. When finished, replace the cap on the bottle.

### Test Tube Pan Flute, Guitar Drum and Trombone

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Drill three holes five-eighths inches in diameter on the top edge of the canvas frame that is three inches away from the left and right edge of the frame and one in the center. Add half inch test tubes that are 3 inches high and where the screw on caps are fully on the outside of the framed page located at the top of the page. To make a base for the test tubes drill a partial slot three inches down from the top edge of the frame that is about one-eighth inches thick and place a one-eighth inch thick by 13 inches long and one-inch wide wooden slat into the slot and secure with wood glue. The test tubes can have repositionable glue or double-sided tape adhered to the bottom of it for securing it in a repositionable fashion to the frame. To one test tube add differing levels of water to the tubes and blow across the opening of the tubes. You will find that each tube has a different sound due to the resonance that occurs when you blow across the tube.

To make a base for the drum drill a partial slot six inches down from the top edge of the frame that is about one-eighth inches thick and place a one-eighth inch thick by 13 inches long and one-inch wide wooden slat into the slot and secure with wood glue. Into this space add a plastic container that is one-inch deep by 3 inches by 3 inches. Open this container and cut out a one and a half inch square in the center and add rubber bands of varying thicknesses around the perimeter of the container. Replace the top. Now, pluck the rubber bands in the container's interior and use a wooden dowel to strike the plastic container top. You can hear different vibrations from the rubber bands and the plastic container acts as a drum.

Finally, drill one hole in the frame that is one-eighths inches diameter one-inch above the bottom of the frame on the opposite side of the frame to where the binding will be attached. Then, obtain two one-eighths inch straws. Cut one straw along a vertical line up the straw in a straight line. For the other straw cut a V into one side of the straw where the V's point is pointing out from the straw and flatten that V portion of the straw. Next, take the cut straw and make the diameter smaller by rolling the straw into itself. Then, insert this straw partially into the V-cut straw. Now, blow into the straw at the V end and pull out the other straw. As the length of the straw gets longer the vibration changes and produces a fluid change of notes. Insert this straw into the single hole near the bottom of the frame. Get two more friends and play a song together!

### Music Laser Light Show

Take a twelve-inch by twelve-inch metal frame that has a recess at least one half inch high and a top that has a clear plastic covering making it possible to see through to the interior of the box. Take a wooden dowel and a laser pointer and shine the laser pointer into the interior of the box through the clear plastic covering in the top and face it towards a wall or sheet that is free of clutter. You should be able to see the reflection of the laser onto the wall or sheet. Now strike the metal frame with the dowel. Based on the vibration, you should be able to see the laser point expand and move.

### Still Waters-Single Circuit Loop

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Drill one hole five-eighths inches in diameter on the top, right side of the canvas frame about two inches from the center. Poke a small nail hole through the center of the page and insert a motor with one rotor. Insert the rotor of the motor through this hole. If needed, glue or tape the motor in place. Then, drill one five-eighths inch partial hole through the bottom edge of the frame. Add a half inch test tube that is twelve.5 inches high by 3 inches wide and one-inch deep and where the screw on cap is fully on the outside of the framed page located at the top of the page. The test tube can have repositionable glue or double-sided tape adhered to the bottom of it for securing it in a repositionable fashion to the frame. Take a bottle that has a nozzle that has an opening like that of a glue bottle having a screw on threads with an adjustable nozzle that you twist to open a small opening in the top and fill this bottle with colored water for extra visibility. Make a spinner wheel by cutting a 5 inch diameter circle out of cardboard with 4 one-inch holes spaced equally around the circumference of the circle. On the other side of the framed page, install the spinner wheel and use thin strips of cardboard to build up the edges of this side of the page to protect the spinner wheel from damage when closing your book. Use the spinner wheel as a template and mark the location of one of the holes on the right side of the canvas attempting to line up the view with the location of the bottle. Remove the spinner wheel temporarily to cut out the hole in the canvas and replace the spinner wheel. Use glue or tape to attach the spinner wheel onto the rotor of the motor. On the side with the recess, take a d-cell battery, two plastic-coated wires with alligator clips attached to each end and a rubber band and connect each alligator clip from each terminal of the battery to each terminal on the motor and watch the spinner wheel spin. Set the bottle of colored water inside the bottle installed in the page and give the bottle a squeeze then adjust the nozzle as well as the top and give the water the right flow. Peer through the hole made on the front of the page while the spinner is spinning to see the water appear to be animated as the movement is aliased through the looking hole in the page as the wheel turns.

### Hologram

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Cut one five-eighths inches square in the middle of the canvas and cardboard. Then, cut four trapezoids that are three eighths inches at one end, five-eighths inches at the other end and one-inch on the other two sides. Attach these four pieces to form an open-ended prism. Place the prism with the three-eighths inch square into the five-eights inch square you made in the canvas and cardboard. Cover the top of the frame with a twelve-inch by twelve-inch cardboard square so that the prism is nestles inside the frame at the cutout. Now, cut out a hole in the bottom and top of the frame that is approximately a half inch circle. Find a video on your phone that has a four-sided hologram video and play it with the widest dimensions for your phone. Set your phone with the video side up facing the hole made in the canvas side of the frame. You and a friend can peer into the holes made in the top and bottom of the frame to see a 3D hologram movie play.

### Color Mixing and Hidden Message

Take a twelve-inch by twelve-inch canvas frame that has a recess at least one half inch high. Place the frame canvas-side down. Take a thin sheet of cardboard that will serve as a base. Place the base in the recess of the frame and slide it so that its edges slide under the edges of the frame edges. Cut one hole three-eighths inches by four inches on the top edge of the canvas frame. Make two spinner wheels by cutting two 5 inch diameter circles out of cardboard with 4 one-inch holes spaced equally around the circumference of the circles about one-fourth inch away from the edge of the circle. Cut one and a half inch circles of clear but different colored mylar and adhere them over the holes in the spinners. Cut a hole in the center of each spinner wheel. Install one spinner wheel on both sides of the framed page so that one protrudes through the slit made in the top of the frame and the other sits on top of the page on the canvas side and protrudes past the edge of the frame. Mark the location of the hole in the center of the spinner wheels and cut a one-eighths inch hole in that location through the cardboard and canvas. Also, mark the location of one of the one-inch holes and cut out that hole in the canvas and cardboard. Start from the inside of the page and place one spinner wheel in place where the slit in the frame was made and install a small three-quarter inch bolt screw through the hole made in the center of the spinner wheel, flip the page over and place the second spinner wheel onto the bolt screw and use a nut to hold the spinner wheel in place. Make sure to install the bolt and nut loosely so that the spinner wheels are free to spin; however, you may use permanent glue to hold the nut in place. Use thin strips of cardboard to build up the edges of the canvas side of the page to protect the spinner wheel from damage when closing your book. Take care not to impede the path of the spinner wheels when installing the extra pieces of cardboard. In the same page, cut a hole three inches by three-eighths inches in the edge of the canvas frame opposite the edge where the binding will be placed towards the middle of that edge of the frame on the opposite side of the page from the spinner. This part of the page will be located away from the edge where the binding will be connected. Make a minibook by taking two 4 inch by 10 inch sheets of cardstock, one on top of the other, fold each of them in half longways then, cut out the center of each page leaving a border of one-inch for each page. Then, taking four different color of mylar, adhere one color of 4 inch by 5 inch mylar to each page. Then, staple all 4 pages in the center to form a four-paged mini book of 4 colors. Glue the edges of the bottom of the bottom page of the book to the cardboard in the framed page so that the pages open toward the opening cut in the edge of the framed page with the hole that is three inches by three-eighths inches. Next, write a message on a three inch by six inch piece of white cardstock in medium-brown or dark colored pencil. Then, take orange, red, yellow or lighter colored pencils and scribble over the message so that it is hard to read the message. Leave some white space on the page. The jumble of colors makes it harder for the brain to process what it sees on the page. But, when you insert the message into the minibook by slipping the message through the slit made in the side of the page so that it can be filtered by the colored page, the colored page filters out that color on the message making it easier to read the message. On the other part of the page, when someone looks through the colored portions of the spinner wheel they will find that different colors can be made, especially when they mix and match the colors by spinning the two wheels. They could even try shining a light through the two colors onto a wall to see it reflected onto a bigger surface.

### Magnet Car

Take a twelve-inch by twelve-inch canvas frame that has a recess at least one-half inches high. Place the frame canvas-side down. Take a thin sheet of cardboard that will serve as a base. Place the base in the recess of the frame and slide it so that its edges slide under the edges of the frame edges. Cut a sheet of aluminum foil to 13 inches by 13 inches and attach it to the sides and bottom of the frame. Take one AA battery and four neodyminium magnets that are the approximate size of the circumference of the battery and attach two of the magnets so that they attract each other. Do the same for the other two. Now, carefully, take one set of magnets in each hand and face them to see which sides repel each other. Once you find the poles that repel each other place one set of magnets on one side of the battery and the other set on the other side of the battery taking care that the poles that repel each other are facing each other while attached to the battery. Lay the page down with the foil facing up. Place the battery-magnet onto the foil in the frame. The battery-magnet will move across the page. By making a homopolar motor using a battery and magnets at either end with the poles facing opposite direction and placing a thin layer of conductive aluminum foil on the surface of the framed page, an electric current runs through the foil creating a magnetic field. This current propels the magnetic car.

### Butterfly Wings—Static Electricity

Take a twelve-inch by twelve-inch by one-inch canvas frame. Cut off the top side of the frame edge. Take a thin sheet of cardboard that will serve as a base. Place the base in the recess of the frame and slide it so that its edges slide under the edges of the frame edges. Take a 11 inch by 11 inch by one-inch acrylic drawer. Attach this drawer to the base by adhesive so that the drawer opens to the top. Take a two inch square of aluminum foil and cut a pair of wings into it. Take a twelve-inch piece of uncoated copper wire. Coil the wire so that about half of the wire is in a coil and the rest is straight. Attach the aluminum wings to the end of the copper wire by manipulating the wire around the foil. Insert the straight end of the wire with aluminum wings into the drawer and close the drawer. It may be necessary to apply a dab of adhesive so that the wire stays put. It may be necessary to bend the wire slightly so that the wings have room to move. Take a balloon and blow it up. Rub the balloon on a carpet or something dry and staticky. Place the balloon close to but not touching the copper coil. Watch the aluminum wings move. This is due to the static electricity moving from the balloon to the wings producing the movement.

### Homemade Projector—Focal Length

Take a twelve-inch by twelve-inch canvas frame that has a recess at least two inches high. Place the frame canvas-side down. Take a thin sheet of twelve-inch by twelve-inch cardboard that will serve as a base. Place the base in the recess of the frame and slide it so that its edges slide under the edges of the frame edges. Cut one square hole one and seven-eighths inches by three and a half inches on the top edge of the canvas frame. In the top edge, adhere a sheet of magnifying paper cut two inches by four inches to the hole in the top edge. Then, take a twelve-inch by twelve-inch cardboard sheet and cut five inches by one half inch holes along the middle of the sheet every inch apart. Place the cardboard sheet on top of the canvas frame and adhere a one-inch Tyvek strip or a one-inch wide ribbon to the corner so that it connects the cardboard sheet to the frame as a living hinge on the side away from the edge that will be connected to the binding. When ready, place the projector on a solid surface facing a clear, uncluttered wall and find a video on your phone. Set the phone to its widest dimensions and make sure to set the phone so that it does not auto-rotate. Set the phone in one of the holes in the top of the cardboard upside down. If needed, place tacks into the interior cardboard to hold the phone in place once you find the proper focal length for your video.

### Periscope & Two—Circuit Parallel Loops

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Drill one hole five-eighths inches by two inches near the bottom of the page on the edge of the canvas frame opposite the edge that will be attached to the binding. Cut a half-inch hole in the right side of the top edge of the frame. Cut a one-eighth inch partial hole one third of the way down from the top edge of the frame on both sides of the frame and insert a seven-eighths inch by one eighth inch wide slat with a one-half inch hole cut out of the right side of the slat, a one half inch hole cut out of the center of the slat and two nail holes on the right and left side of the slat about one-fourth inches from each edge of the slat. Next, make a periscope by taking a one-half inch paper tube twelve-inches long and cutting a 45-degree angle slit nearly through the tube about one-inch up from the bottom edge. Flip open the tube at the slit and adhere a half-inch circle of CD material where the bottom of the CD or the shiny, holographic side is facing up into the tube. Cut a hole above the slit in the tube to the right of the tube so that when you peer into the tube you can see up the tube. Make a second slit at the top one-third of the tube at a 45-degree angle. Insert and adhere a one-half inch mirror at this slit and cut a hole facing to the left and below the slit. Now, when you peer into the bottom hole you should be able to see into the interior of the page in front of the periscope. Decorate the tube to look like a staircase by adding markings for stairs and clay railings. On a sheet of paper 11 inches by 11 inches draw, stamp and color a scene of a house with a staircase on one side, a clock, chairs and make a clay chandelier in the center of the page. Stamp or draw a man with a caption stating, “what was that?” Draw squiggly lines from the top third of the page below the wooden slat down towards the center of the page. Attach this to the cardboard base and then insert the wooden slat. Insert the periscope into the hole cut in the wooden slat on the right side of the page and adhere it to the cardboard. On the page above the slat adhere a molding of a squirrel or a picture of a squirrel so that it is perpendicular to the cardboard. Add some florescent, glow-in-the-dark glue to the edges of the molding or picture so that it can be seen in the dark. Then, further behind that image, draw a picture of a lightning bolt with sparks and use florescent, glow-in-the-dark glue to highlight the picture so that it can be seen in the dark. Install this so that it is perpendicular to the cardboard base as well. Then, on the left side of the page install a door by using a large popsicle stick and attaching this by paper hinge to a two inch wide by six inch piece of cardstock that has been modified by debossing to look like a door front. Take this door and make a second paper hinge connecting the door to the left edge of the frame. Beneath the door, attach a housing for the battery that is one and a half inches wide by three inches tall and one and a half inches deep. Attach this to the base using permanent glue making sure to leave a half-inch gap at the bottom of the page for connections that will be made to the battery. Place a d-cell battery with a rubber band wrapped around it touching its two terminals into the housing and close the door. Then, install and adhere the LED light that is on a seven-eighths inch platform with two prongs into the hole in the slat. Then, make a table by taking a buzzer that has two connecting wires connected to it and wrap a piece of paper around this and cut the paper to fit the buzzer which is about three-eighths inch in diameter and a half-inch tall. Then, make a top that is a half-inch diameter circle cut out of cardboard. Cover this structure with fabric to look like a table. House the buzzer under the table structure. Next, make a throw rug by taking a piece of ribbon that has a design like a rug or that is furry. Attach this to a piece of cardboard that is four inches by seven-eighths inches and use a paper hinge to attach this to the front, center of the bottom of the page. Make sure the hinge allows about a quarter-inch gap between the cardboard and the base of the bottom of the frame. Next, make a switch by taking a piece of heavy cardstock seven-eighths inch by two inches long and piercing two pin holes in the center of the paper about three-eighths inch from the left and right side of the paper. Into the pin holes affix two metal brads where the round portion of the brad is underneath the cardstock and the brads are on top. Next, take a paperclip and open one of the brads to catch the loop of the paperclip. Install the switch on the right side of the page at the bottom. Next, take insulated wires and make connections from the battery, to the switch, to the light then from the light to the battery again. Then, take more insulated wires and make connections from the battery, to the buzzer, to the switch, to the battery again. With each connection, take care to start with the wires touching one terminal of the battery and ending with touching the other terminal of the battery. Use the carpet, the door, the table and the periscope to hide where you ran the wires to make the page look neat and tidy as possible. Cover the page with a clear sheet of acrylic that has been colored black from the place where it touches the slat in the page to the top of the page and measures twelve-inches by 10 inches so that it is open at the bottom. When ready, touch the paperclip to the other metal brad which finishes the connection on the parallel circuit of the buzzer and the light and see the light come on and the buzzer sound.

Look into the periscope and see the light being broken up by the light being reflected off of the CD piece. Then, peer up into the periscope and see the squirrel and the picture of the lightning bolt in the attic portion and how it is lit up by the florescent pigment in the glue.

Inside—Outside Optical Illusion

This optical illusion involves some math and even Psychology. Take two twelve-inch by twelve-inch clear acrylic trays that has a recess at least one-inch high. The base in each of these trays will be the back face of each tray since it is sturdy enough to hold the materials. Take a twelve-inch by twelve-inch thin sheet of cardstock that will serve as a cover. Decorate the cover with paint to mimic a field of grass. Then, obtain a mold of a bunny that has a recess no deeper than one-inch and apply thin layers of paper clay to the interior of the mold making sure to leave a recess and not filling the mold. Wait for the clay to dry. In the meantime, obtain an image of a block that has three sides and a flap. Color the template and cut out the image. Make valley folds along the edges of the three blocks. Paste the flap to the backside of the nearest block image. Paste this to the inside base of one of the clear acrylic trays. Once the paper clay bunny is dry demold it and trace the outer image of the bunny to the underside of the painted cardstock. Cut out the image of the bunny. Color the demolded bunny on the inside of the mold. Then, adhere the bunny to the cardstock so that the interior of the mold is facing the painted side of the cardstock. Adhere this bunny and painted cardstock to the inside of the other acrylic tray. Then, adhere the outside of each base on each acrylic tray together making one front and back page. When ready, have a friend view the page from the front and note what they think. Then, have another friend view the colored blocks on the other side of the page and note what they think. Then, have both friends view the pages from the side and note what they think. Explain that the images are in reverse and your brain automatically calculates the images as right-side out by doing mental math. When you see the reverse side of the images your brain realizes that it has been fooled. However, if you were not originally fooled it may be due to Psychological reasons; one such reason being the possibility of Schizophrenia. Or, maybe you come from a very special tribe in Africa that are not easily fooled by such illusions.

Firefly Optical Illusion Using a Generator

This is an investigation page that involves math and electrical wiring. Take a twelve-inch by twelve-inch canvas frame that has a recess at least one-inch high. Place the frame canvas-side down. Take a thin sheet of wood that will serve as a base. Place the base in the recess of the frame and slide it so that its edges slide under the edges of the frame edges. Take a mirror that is about 10.5 by 10.5 inches and place it on top of a thin sheet of cardboard 11 by 11 inches wide with a 10.5 by 10.5 inch cutout in the center. Then, adhere the cardboard on top of the wooden board and then adhere the mirror to the opening made in the cardboard. Drill one hole five-eighths inches by three inches in diameter on the bottom edge of the canvas frame away from the edge where the binding will be attached. In the bottom center of the inside of the framed page, adhere an led light that has a platform with prongs on it for connecting wires. To these two prongs, attach one alligator clipped insulated wire that is about 2 feet long to each prong and run the wires to the outside of the frame. Attach the other side of the alligator clips to the two terminals on a motor. Then, attach a digital clock with two wires about 2 feet long to the bottom of the frame near the hole cut in the side of the frame. Adhere a twelve by twelve-inch one-eighth inch clear plastic or clear acrylic sheet with two-way mirror film, which is about 80 percent silver coated, or holographic mylar adhered to the inside of the sheet to the front of the framed page and let dry. When ready, obtain two potatoes and use two copper and zinc strips with one connecting wire and use the connecting wire to connect one side to a zinc and one side to a copper strip. Then, place these two strips into two different potatoes sitting side by side. Take the other two strips and attach one of the wires coming from the digital clock and connect one wire to a copper strip and the other wire to a zinc strip. Then, take the copper strip and insert it into the potato that already has a zinc strip inserted into it. Make sure to place it right next to the zinc strip but do not let it touch. Take the zinc strip and insert it into the potato with the copper strip already inserted into it. Make sure to place it right next to the copper strip but do not let it touch. You should see the digital clock begin to operate. Next, use a piece of cotton twine about 14 inches long, and wrap it around the rotor of the motor about 20 times. Quickly yank the string so that it makes the rotor spin and the motor acts as a generator making the light it is connected to within the page light up. Because the acrylic cover acts like a two-way mirror, it bounces the light back and forth between the true mirror and the two-way mirror while still being able to be seen by the viewer through the acrylic cover; thus, producing what is called an infinity effect where you can see the same image several times in the mirror. Have the person operating the generator pick a number between 1 and 5 and see how many times they can get the light to light up using the generator in the amount of time in minutes they chose when they picked a number one through five. Then, tell that person to estimate the population of fireflies based on the number of times they were able to light the light using the generator which is the number of times the person saw fireflies multiplied by the number of iterations or reflections they can see in the infinity mirror. If the number falls below a number that was set before the game began, then, the population of fireflies is low and may be endangered. You can have the person come up with a plan to study fireflies to boost their population. But, if the population is found to be above the number that was chosen, the fireflies are not endangered.

Crank the Propeller—Magnet Motor

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Draw a picture of an airplane and attach this to the cardboard base. Take a 24 inch by twelve-inch manila sheet of paper and fold it in half longways. Cut a hole in the center of this folded manila sheet leaving a border of an inch on all sides. The hole is through the top and bottom of the sheet. Next, cut a half-inch semicircle in the edge of the manila sheet that is opposite the fold as a finger pull. Take an 11 inch by twelve-inch sheet of cardstock and write the instructions for the experiment onto the cardstock leaving an inch border all around. Do not write or make marks on the outside of the inch border. Cut one-half inch by one-half inch tabs and glue them to the top left and bottom left edge of the cardstock. Use glue or one-eighth inch double-sided tape to glue the top edge, bottom edge and one-half inch from the top edge toward the center and bottom edge toward the center of the manilla sheet of paper. Fold the sheet in half with the cardstock inside facing up making the pocket. Attach this pocket to the canvas frame so that the folded side is nearest the edge of the canvas frame where it will be attached to the binding. Inside the page, place two metal hooks, one bar magnet, one six inch by one-inch by two inch sponge, a d-cell battery, a foot of enamel coated magnet wire, an inch diameter dowel, a rubber band, a piece of sanding paper, a propeller made of lightweight paper and two plastic coated wires with alligator clips at each end. The person will place the hooks into the sponge and attach one alligator clip wire to each hook. Then, the person will place the bar magnet in between the hooks. Then, the person will wrap the wire around the dowel several times to make a loop of wire where each side of the wire will have at least two inches of extra wire not looped. Next, the person will wrap the unlooped wire around the loops a few times until there is about an inch left on either side and the wire ends are on opposite sides of the loop. Then, the person will strip the enamel off of one side of each wire and attach the paper propeller to one end of the loop. Then, the person will place the ends of each loop through the loop of each hook. They should see the loop begin to move back and forth. Then, the person will attach the other end of each alligator clip to each side of the d-cell battery and secure this with the rubber band. If the loop isn't spinning by itself by now the person should give the loop a little push and watch it turn. A push is sometimes needed because the coil needs to make electrical contact with the paperclip which will allow the current to run through the coil. Because the magnet wire only has its coating stripped off of one side it may need a push to get the whole cycle started where electricity can flow from the battery through the coil and back to the battery again.

### Computer Monitor Hidden Message Optical Illusion

Take a twelve-inch by twelve-inch canvas frame that has a recess at least one-inch high. Place the frame canvas-side down. Take a thin sheet of cardboard that will serve as a base. Place the base in the recess of the frame and slide it so that its edges slide under the edges of the frame edges. Drill two slots five-eighths inches in diameter on the left and right edge of the canvas frame and a half inch diameter hole in the cardboard and canvas. Obtain an LCD computer monitor that is no bigger than 11 inches by 11 inches. Take off the polarizing film that is the screen's first layer. Set the screen inside the frame and attach with glue or a strong adhesive. Plug in the screen to a socket and plug the other cable into a computer tower. Find a video or type a message using a word processor. Use polarizing sunglasses to see the image or message. Alternatively, a black board without its polarizing film which is its screen's top layer, can be installed into the frame and the same results will be achieved.

### Star Book

Take a lazy-susan platform and attach a wooden base about 14 inches in diameter on top using glue. Then, take four 8 by 10 canvas frames and attach them to the wooden base vertically so that the frames and base are perpendicular to one another by using nails. You will notice that there are small gaps of space that allow you to see to the interior of the space. You can face the recesses towards the center or towards the outside depending on what effect you are looking to make. However, if you face the frames with the recesses facing inward and place figures in them that are showing progressive movements, you will be able to recreate the zeotrope experiment when you turn the platform and peer through the gaps made from the spaces between the canvas frames. You can also recreate the still waters experiment by placing a cylindrical 5 inch by 10 inch acrylic fish tank with a hole in its upper perimeter and a pump, a half-inch pipe, and a bluetooth cordless speaker that connects to your phone that has a tone generator application set to 24 hz sine wave and strobe lights or a second phone with a strobe light application where the setting is 24 fps. Place the speaker at the top of the container, place the pump inside the container and connect the pipe to the pump, run the pipe to the top of the container using the hole in the container and make sure it touches the speaker and flows back into the container, set the strobe light or application, fill the container with enough water to make the pump flow and not overflow the container, turn on the pump, sound through the speaker, lights, and turn off the lights in the room and you will see a still water effect with a wave pattern to the water. If you adjust the strobe light setting to 23, it will appear that the water is flowing backwards. If you adjust the strobe light setting to 25, it will appear that the water is flowing forward in slow motion.

### Volcano—Premade Sound, Movement and Lights

Take a twelve-inch by twelve-inch canvas frame that has a recess at least one-inch high. Place the frame canvas-side down. Take a thin sheet of cardboard twelve-inches by 8 inches that will serve as a base. Place the base in the recess of the frame and slide it so that its edges slide under the edges of the frame edges. Take a battery-operated set of LED lights, a battery-operated movement module that shakes and has a platform a quarter of an inch by a quarter of an inch wide that has a trigger that happens when you open the page of a book and a sound module that is battery-operated that is also operated by the opening of a book and set the battery portion of the modules on a piece of foam board twelve-inches by 4 inches. Run the top portion of the movement module to the middle of the page. Take an additional piece of foam board and cut out a section where the batteries of the lights, movement and sound modules will rest. Adhere this to the top of the first piece of foam board lies. Record the sound you want in the sound module following the directions given with the product. Now, make a volcano dimensional element by cutting a brown sheet of cardstock and attaching curling ribbon to the top of this elements narrow end. Attach a piece of cardstock that has an image of a forest to the cardboard base. Attach the volcano dimensional element to the quarter inch base of the movement module and adhere the entire movement module to the center of the page on the base. Run the lights all along the edge of the page adhering the lights to the edge of the frame. Make sure the batteries have been installed in the lights, movement modules and sound module and adhere these down into the spaces made in the foam board. Then, make a mini book that is twelve-inches by 4 inches. Begin by taking two sheets of cardstock this dimension and laying them on top of one another. Then, fold them in half the longways so that they form a book 4 inches by 6 inches. Open up the fold and staple the book at the fold. Next, write the story literature on the pages. Adhere the bottom of the minibook to the top of the foam board making sure not to cover any of the battery housings with glue. Next, attach the tab that extends from the sound and movement modules to the second page of the minibook by cutting a thin slit in the bend of the fold of the book where it lies closest to the module and glue the tab onto the second page. Let this dry so that it doesn't get stuck to any other pages. When ready, turn on the lights on the page and flip the pages of the minibook so that the volcano shakes like it is beginning to erupt and so that the story can be read aloud by the sound module.

### Binding Method

The preferred binding method is post binding using Chicago screws. This can be accomplished by taking a one-inch ring binder and cutting off the covers with the covering attached at the segments that have a living hinge attached to the cover. Cut two holes, one one-inch from the top and one-inch from the bottom of each cut-off cover. The holes are approximately one-eighth inch, big enough to tightly fit the Chicago Screws. Take both covers and lay them side by side. Fold up the portion that has the living hinge and attach one part of the Chicago screw into one of the holes so that it extends toward the cover on the other side. Then, line up the holes in the other cover with the Chicago screws and insert the other portion of the Chicago screw through the second set of holes in the other cover and into the other Chicago screw. For each framed page, also known as a page element, glue or screw a plastic or wooden slat that has screw-sized holes at intervals along the center length of the slat. Depending on the style of the book, determine which side needs to have the slat. In this case, our book will be a right to left book; so, the slat will be attached to the left side of the pages. Once each page element has a slat with holes attached to it, you can apply an elastic band that is narrower than the width of the page to the slat where the elastic band has a ring attached to the end that will be screwed down with a screw through one of the holes in the slat. The screw has a head that allows the ring to be caught under it when screwed down. So, when the top ring is screwed down, you run the elastic behind the Chicago screws to be caught under a second screw at the bottom of the page; thus, holding in the page. The post binding allows extensions in the event you want to add more pages. Secondly, the slats allow you to switch from screws to hooks in the event you want to change your binding method to ring binding. Just screw in a hook that has a screw attached into the slat that lines up at the location of the rings in the ring binding. Then slip the rings in the page element over the rings in the ring binding and close the binder.

It should be understood, of course, that the foregoing relates to exemplary embodiments of the invention and that modifications may be made without departing from the spirit and scope of the invention as set forth in the following claims.

What is claimed is:

1. A method of producing a teaching aid for science, technology, engineering, arts, and mathematics (STEAM) related lessons, the method comprising:
providing one or more dimensional elements, each dimensional element having a demonstrative component and an operative component operatively associated thereto, the demonstrative component configured to provide a demonstration of STEAM, and wherein the operative component directly or indirectly urges said demonstration of STEAM;
providing two or more frames, each frame defining a recess; and
joining each dimensional element to one or more frames in such a way that the demonstrative component is disposed inside the recess.

2. The method of claim 1, binding the two or more frames in such a way that the two or more frames are movable relative to each other between a closed position and an open position wherein the two or more frames are successively visible.

3. The method of claim 1, wherein the demonstrative component comprises at least an object, element, hinge and wedge and the operatively associated operative component comprises at least a handle and a magnet.

4. The method of claim 1, wherein the demonstrative component comprises at least an object, element, a ball and magnets and the operatively associated operative component comprises at least a plunger.

5. The method of claim 1, wherein the demonstrative component comprises at least an object, element, a gear, screw, and pulley and the operatively associated operative component comprises at least a turn activated extension/retraction element and turn rods.

6. The method of claim 1, wherein the demonstrative component comprises at least an object, element, a pulley and the operatively associated operative component comprises at least a turn rod and on/off button.

7. The method of claim 1, wherein the demonstrative component comprises at least an object, element, a ball and the operatively associated operative component comprises at least an inclined plane and lever.

8. The method of claim 1, wherein the demonstrative component comprises at least an object, element, a lever, gravity and friction and the operatively associated operative component comprises at least a string handle.

9. The method of claim 1, wherein the demonstrative component comprises at least an object, element, friction and the operatively associated operative component comprises at least a handle.

10. The method of claim 1, wherein the demonstrative component comprises at least an object, element, pressure and buoyancy and the operatively associated operative component comprises at least a pressure bulb.

11. The method of claim 1, wherein the demonstrative component comprises at least an object, element, metal pipe, hydraulics, magnetism, Lenz and Faraday laws and the operatively associated operative component comprises at least a magnet and syringe.

12. The method of claim 1, wherein the demonstrative component comprises at least an object, element, optical illusion, aliasing and the operatively associated operative component comprises at least a hand-spinning movements.

13. The method of claim 1, wherein the demonstrative component comprises at least an object, element, metal, magnetism, centrifugal force, diffusion, reflection and bioluminescence and the operatively associated operative component comprises at least a screw, handle, and on/off switch.

14. The method of claim 1, wherein the demonstrative component comprises at least an object, element, a temperature-sensitive orb/sphere and the operatively associated operative component comprises at least an on/off switch.

15. The method of claim 1, wherein the demonstrative component comprises at least an object, element, a siphon and the operatively associated operative component comprises at least free-flowing fluid.

16. The method of claim 1, wherein the demonstrative component comprises at least an object, element, a wheel and axle, pressure, gravity, water-filled tube and the operatively associated operative component comprises at least a wheel-type handle.

17. The method of claim 1, wherein the demonstrative component comprises at least an object, element, a fluid and the operatively associated operative component comprises at least a chemical.

18. The method of claim 1, wherein the demonstrative component comprises at least an object, element, a water marble and the operatively associated operative component comprises at least a hand-spinning movement.

19. The method of claim 1, wherein the demonstrative component comprises at least an object, element, a fluid/chemical and the operatively associated operative component comprises at least an on/off switch.

20. The method of claim 1, wherein the demonstrative component comprises at least an object, element, a fluid and gas and the operatively associated operative component comprises at least a chemical.

21. The method of claim 1, wherein the demonstrative component comprises at least an object, element, a gas and fluid and the operatively associated operative component comprises at least one chemical.

22. The method of claim 1, wherein the demonstrative component comprises at least an object, element, a fluid, tube, rubber band and straw and the operatively associated operative component comprises at least a percussion and air flow.

23. The method of claim 1, wherein the demonstrative component comprises at least an object, element, metal, a sound/vibration and the operatively associated operative component comprises at least an on/off switch and percussion.

24. The method of claim 1, wherein the demonstrative component comprises at least an object, element, a motor, electricity, aliasing, and optical illusion and the operatively associated operative component comprises at least an adjustable nozzle, a fluid and electrical connection.

25. The method of claim 1, wherein the demonstrative component comprises at least an object, element, a prism and optical illusion and the operatively associated operative component comprises at least a video and a software application.

26. The method of claim 1, wherein the demonstrative component comprises at least an object, element, a wheel and axle and optical illusion and the operatively associated operative component comprises at least an on/off switch.

27. The method of claim 1, wherein the demonstrative component comprises at least an object, element, a homopolar motor, metal, magnets and electrical current and the operatively associated operative component comprises at least a battery, magnet, and assembly.

28. The method of claim 1, wherein the demonstrative component comprises at least an object, element, metal, static electricity and the operatively associated operative component comprises at least a balloon.

29. The method of claim 1, wherein the demonstrative component comprises at least an object, element, a magnification sheet and the operatively associated operative component comprises at least a video and a software application.

30. The method of claim 1, wherein the demonstrative component comprises at least an object, element, a mirror, electrical charge, and vibration and the operatively associated operative component comprises at least an on/off switch.

31. The method of claim 1, wherein the demonstrative component comprises at least an object, element, an inverted 3-dimensional image, light and optical illusion and the operatively associated operative component comprises at least a hand manipulating the page and viewing.

32. The method of claim 1, wherein the demonstrative component comprises at least an object, element, a motor and 2-way mirror/film and the operatively associated operative component comprises at least an electrical connection and chemicals.

33. The method of claim 1, wherein the demonstrative component comprises at least an object, element, a spinner, magnet, wires, and battery and the operatively associated operative component comprises at least an electrical connection, handle, hand movement, and assembly.

34. The method of claim 1, wherein the demonstrative component comprises at least an object, element, a LED monitor and optical illusion and the operatively associated operative component comprises at least an electrical connection, software application, typing device, video, a polarizing lens.

35. The method of claim 1, wherein the demonstrative component comprises at least an object, element, a fluid, wireless speaker, pump, aliasing, and lights and the operatively associated operative component comprises at least one software application, on/off switch, pump, and adjustable nozzle.

36. The method of claim 1, wherein the demonstrative component comprises at least an object, element, a movement and art and the operatively associated operative component comprises at least a trigger, switch, electrical connection, and hand-movement.

37. The method of claim 2, further comprising attaching a page backing along one side of each frame so that the page backing further defines the recess, respectively.

38. The method of claim 37, further comprising attaching a transparent page cover along one side of each frame so that the transparent page cover further defines the recess, respectively.

39. The method of claim 38, further comprising attaching multiple transparent page covers along both sides or inside of each frame so that the transparent page cover further defines the recess, respectively.

40. The method of claim 39, wherein the operative component is disposed outside the recess.

41. The method of claim 40, further comprising joining at least one dimensional element to the page backing, respectively.

42. The method of claim 41, wherein the book is adapted so that a user is enabled to reach into the page to interact with the dimensional elements or manipulate the space of the page recess.

43. The method of claim 1, wherein frames and page elements attach to a spinning base where frames and page elements and base are perpendicular to one another and the frames and page elements stand vertically from the base.

44. The method of claim 43, wherein any or all components along with any instructions, tools, objects, devices and materials are combined in any way desired to form a kit in which to create a book.
